(19) United States
(12) Patent Application Publication
(10) Pub. No.: US 2010/0027700 A1
(43) Pub. Date: Feb. 4, 2010

(54) Communication System, Base Station, Terminal and Communication Method of OFDM System

(75) Inventor: Toru Sahara, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/521,288

(22) PCT Filed: Dec. 19, 2007
(86) PCT No.: PCT/JP2007/074438

§ 371 Date: Sep. 1, 2009

(30) Foreign Application Priority Data
Dec. 25, 2006 (JP) 2006-348212

(51) Int. Cl. H04L 27/28

(52) U.S. Cl. 375/260

(57) ABSTRACT

Provided are a communication system, a base station, a terminal and a communication method of an OFDM system, using an adaptive array, which are capable of alleviating signal quality deterioration by reducing the probability of instant peak power raises. The communication system includes a data producing means 11 for acquiring communication network side data and a user assignment band in a predetermined format, encoding the data, and performing mapping for the user assignment band, null symbol inserting means 12,28 for filling a region having no data with null symbols if the amount of data for the user assignment band is small, and symbol interleave means 13,29 for performing symbol interleave on the entire user assignment band and inserting known symbols in a predetermined symbol position within the user assignment band.

### TECHNICAL FIELD

The present invention relates to a communication system, a base station, a terminal and a communication method of an OFDM system.

### BACKGROUND ART

A TDMA (Time Division Multiple Access)/TDD (Time Division Duplex) system, which is a combination of TDMA and TDD, has been employed as a wireless access system such as a digital mobile telephone system, a PHS system or the like. In addition, an OFDMA (Orthogonal Frequency Division Multiplexing Access) system, being a communication system using an OFDM technique, has been proposed.

An OFDM system is a system for dividing a carrier, which modulates data, into a plurality of ‘sub carriers (subdivided carriers)’ orthogonal to each other, distributing data signals over the respective sub carriers, grouping some of the plurality of sub carriers, and assigning one or more sub carrier groups to each user for multiplex communication. Each sub carrier group is called a sub channel. That is, each user conducts communication using one or more sub channels assigned thereto. The number of sub channels is adaptively varied depending on the amount of data for communication, propagation environments and so on.

For the purpose of maintaining good communication quality by suppressing the effect of communication in other base stations, there has been proposed an adaptive array technique using an adaptive array for directional transmission/reception when a base station transmits a down link signal to a terminal or when a base station receives a down link signal from a terminal.

For signal processing by the adaptive array, a known signal, which is called the training signal or pilot signal and is transmitted from a terminal, is received and a reception coefficient (weight vector or weight) for each of antennas of base stations is calculated. The signal from the desired terminal is accurately extracted by calculating the weight vector (reception weight vector) and carrying out an adaptive control, that is, by multiplying each reception signal of a plurality of antennas with each element of the reception weight vector.

By such processing, an uplink signal from the antenna of each terminal is received by an adaptive array antenna of a base station and is separated and extracted according to reception directionality.

By outputting a signal, which is generated by multiplying a transmission signal with each element of a transmission weight vector calculated based on the reception weight vector, from each of a plurality of antennas, a downlink signal from a base station to a terminal is transmitted according to transmission directionality for an antenna of the terminal (see Patent Document 1).

[Patent Document 1] Japanese Unexamined Patent Application Publication No. 2003-283411

### DISCLOSURE OF THE INVENTION

### Problem to be Solved by the Invention

For example, when downlink transmission weight is generated based on reception weight calculated by a reception signal such as an uplink signal of a base station using a conventional adaptive array technique in an OFDM communication system, there is a need for a terminal to transmit data or a known signal as an idle burst even when the uplink signal has no communication data of an application or the like used by a terminal user, so that the reception weight can be calculated in the base station. In this case, if a training symbol or a pilot is used as it is, the uplink signal increases in its amplitude component of OFDM symbols at a timing of a communication frame, which is likely to increase peak current instantly. This may cause a problem of deterioration of quality of OFDM symbols due to amplifier load caused by the increase of PAPR (Peak to Average Power Ratio) or over-saturation caused by an operation delay of AGC (Automatic Gain Control). This results in significant difficulty in hardware design.

To overcome the above problem, it is an objective of the present invention to provide a communication system, a base station, a terminal and a communication method of an OFDM communication system, which are capable of alleviating deterioration of signal quality by reducing the probability of instant raises in peak power.

### Means for Solving the Problem

In order to achieve the above-mentioned objective, a communication system of an OFDM system according to the present invention includes: data producing means for acquiring communication network side data and a user assignment band in a predetermined format, encoding the data, and performing mapping for the user assignment band; null symbol inserting means for filling a region having no data with null symbols if the amount of data for the user assignment band is small; and symbol interleave means for performing symbol interleave on the entire user assignment band and inserting known symbols in a predetermined symbol position within the user assignment band.

With the above configuration, the wave number of an OFDM combined signal can be reduced by filling unused data portions other than known symbols such as the training symbol required for weight operation or synchronization of an adaptive array with null symbols and performing symbol interleave on all the user symbols, and accordingly, it is possible to lower the probability of instant peak power raises, resulting in the alleviation of signal quality deterioration.

A base station according to the present invention is a base station that conducts a communication of an OFDM system and that includes: a signal processor that processes a received signal and/or a signal to be transmitted, wherein the signal processor includes a reception side user domain processor and/or a transmission side user domain processor that perform the process for each user, and wherein the reception side user domain processor includes: a reception weight calculating unit that performs propagation path correction from a pilot symbol and calculates reception weight from a training signal; a desymbol interleave unit that performs desymbol interleave on a user assignment band; and a null symbol deleting unit that deletes null symbols from the desymbol interleaved user assignment band and extracts desymbols.

With the above base station configuration, it is possible to delete null symbols from the user assignment band and extract data symbols by a process of desymbol interleave in the uplink.

In the base station, the transmission side user domain processor includes: a data producing unit that encodes data and performs mapping for the user assignment band; a null symbol inserting unit that fills a region having no data with null symbols if the amount of data for the user assignment band is small; and a symbol interleave unit that performs symbol interleave on the entire user assignment band and inserts known symbols in a predetermined symbol position within the user assignment band.

With the above base station configuration, the wave number of an OFDM combined signal can be reduced by filling unused data portions other than known symbols such as the training symbol required for weight operation or synchronization of an adaptive array with null symbols in the downlink and performing symbol interleave on all the user symbols, and accordingly, it is possible to lower the probability of instant peak power raises, resulting in the alleviation of signal quality deterioration.

A terminal according to the present invention is a terminal that conducts a communication of an OFDM system and that includes: a signal processor that processes a received signal and/or a signal to be transmitted, wherein the signal processor includes: a data producing unit that encodes data and performs mapping for a user assignment band; a null symbol inserting unit that fills a region having no data with null symbols if the amount of data for the user assignment band is small; and a symbol interleave unit that performs symbol interleave on the entire user assignment band and inserts known symbols in a predetermined symbol position within the user assignment band.

With the above terminal configuration, the wave number of an OFDM combined signal can be reduced by filling unused data portions other than known symbols such as the training symbol required for weight operation or synchronization of an adaptive array with null symbols in the uplink and performing symbol interleave on all the user symbols, and accordingly, it is possible to lower the probability of instant peak power raises, resulting in the alleviation of signal quality deterioration.

A terminal according to the present invention is a terminal that conducts a communication of an OFDM system and that includes: a signal processor that processes a received signal and/or a signal to be transmitted, wherein the signal processor includes: a desymbol interleave unit that performs desymbol interleave on a user assignment band; and a null symbol deleting unit that deletes null symbols from the desymbol interleaved user assignment band.

With the above terminal configuration, it is possible to delete null symbols from the user assignment band and extract data symbols by a process of desymbol interleave in the downlink.

A communication method of an OFDM system according to the present invention includes the steps of: acquiring communication network side data and a user assignment band in a predetermined format, encoding the data, and performing mapping for the user assignment band; filling a region having no data with null symbols if the amount of data for the user assignment band is small; and performing symbol interleave on the entire user assignment band and inserting known symbols in a predetermined symbol position within the user assignment band.

According to the above communication method, the wave number of an OFDM combined signal can be reduced by filling unused data portions other than known symbols such as the training symbol required for weight operation or synchronization of an adaptive array with null symbols and performing symbol interleaving on all the user symbols, and accordingly, it is possible to lower the probability of instant peak power raises, resulting in the alleviation of signal quality deterioration.

### Advantage of the Invention

The present invention can provides a communication system, a base station, a terminal and a communication method of an OFDM system, which are capable of alleviating of signal quality deterioration by reducing the probability of instant peak power raises.

### BRIEF DESCRIPTION OF THE DRAWINGS

FIG. 1 is a functional block diagram of a base station according to an embodiment of the present invention.

FIG. 2 is a functional block diagram of a terminal according to an embodiment of the present invention.

FIG. 3 is a flow chart for explaining the reception process of a base station according to an embodiment of the present invention.

FIG. 4 is a flow chart for explaining the transmission process of a base station according to an embodiment of the present invention.

FIG. 5 is a flow chart for explaining the reception process of a terminal according to an embodiment of the present invention.

FIG. 6 is a flow chart for explaining the transmission process of a terminal according to an embodiment of the present invention.

FIG. 7 is a view to explain an exemplary method of inserting a symbol into a user assignment sub channel in a communication system according to an embodiment of the present invention.

FIG. 8 is a view to explain an example of symbol interleaving in a communication method of a base station and a terminal of a communication system according to an embodiment of the present invention.

FIG. 9 is a waveform diagram (a combined wave including one sub carrier) showing peak component by the difference in OFDM wave numbers.

FIG. 10 is a waveform diagram (a combined wave including 10 sub carriers) showing peak component by the difference in OFDM wave numbers.

### DESCRIPTION OF REFERENCE NUMERALS AND SIGNS

1, 21: WIRELESS UNIT (PA/RF unit/IF unit/BB unit)
2, 22: SIGNAL PROCESSOR
3, 23: FFT UNIT
4: RECEPTION SIDE USER DOMAIN PROCESSOR
5: RECEPTION WEIGHT CALCULATING UNIT
6, 24: DESYMBOL INTERLEAVE UNIT
7, 25: NULL SYMBOL DELETING UNIT
8, 26: DATA DEMODULATING UNIT
9: TRANSMISSION SIDE USER DOMAIN PROCESSOR
10: BASE STATION
11: DATA PRODUCING UNIT (DATA PRODUCING MEANS)
12, 28: NULL SYMBOL INSERTING UNIT (NULL SYMBOL INSERTING MEANS)
13, 29: SYMBOL INTERLEAVE UNIT (SYMBOL INTERLEAVE MEANS)
14: TRANSMISSION WEIGHT CALCULATING UNIT
15, 30: IFFT UNIT
16: ANTENNA COMBINING UNIT
20: TERMINAL

### PREFERRED EMBODIMENTS FOR CARRYING OUT THE INVENTION

Hereinafter, a communication system according to an embodiment of the present invention will be described in detail with reference to the drawings.

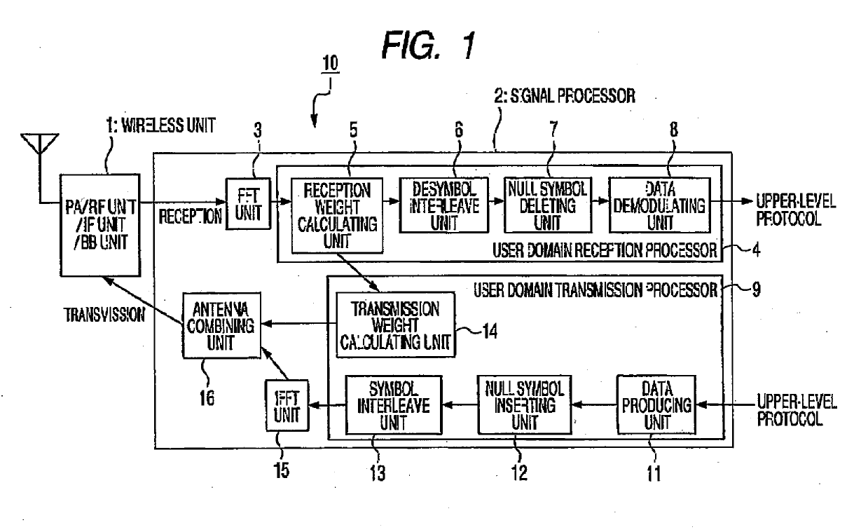

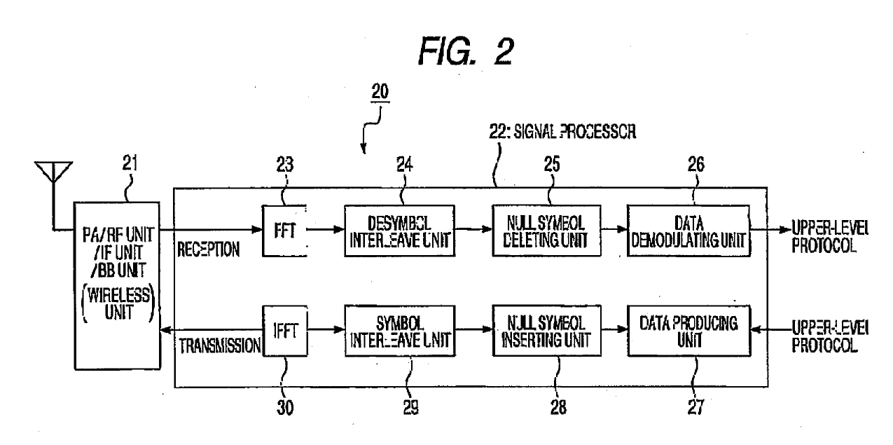

FIG. 1 is a functional block diagram of a base station according to an embodiment of the present invention and FIG. 2 is a functional block diagram of a terminal.

First, a functional configuration of a base station according to an embodiment of the present invention will be described.

Base station 10 of this embodiment includes wireless unit (PA/RF unit/IF unit/BB unit) 1 and signal processor 2 which processes a received signal and a signal to be transmitted.

Signal processor 2 includes FFT unit 3, reception side user domain processor 4, transmission side user domain processor 9, IFFT unit 15 and antenna combining unit 16.

Reception side user domain processor 4 includes transmission weight calculating unit 5, desymbol interleave unit 6, null symbol deleting unit 7 and data demodulating unit 8.

Transmission side user domain processor 9 includes data producing unit 11, null symbol inserting unit 12, symbol interleave unit 13 and transmission weight calculating unit 14.

Next, a functional configuration of a terminal according to an embodiment of the present invention will be described.

Terminal 20 of this embodiment includes wireless unit (PA/RF unit/IF unit/BB unit) 21 and signal processor 22 which processes a received signal and a signal to be transmitted.

Signal processor 22 includes FFT unit 23, desymbol interleave unit 24, null symbol deleting unit 25, data demodulating unit 26, data producing unit 27, null symbol inserting unit 28, symbol interleave unit 29 and IFFT unit 30.

Next, a communication method of base station 10 in the communication system according to this embodiment will be described.

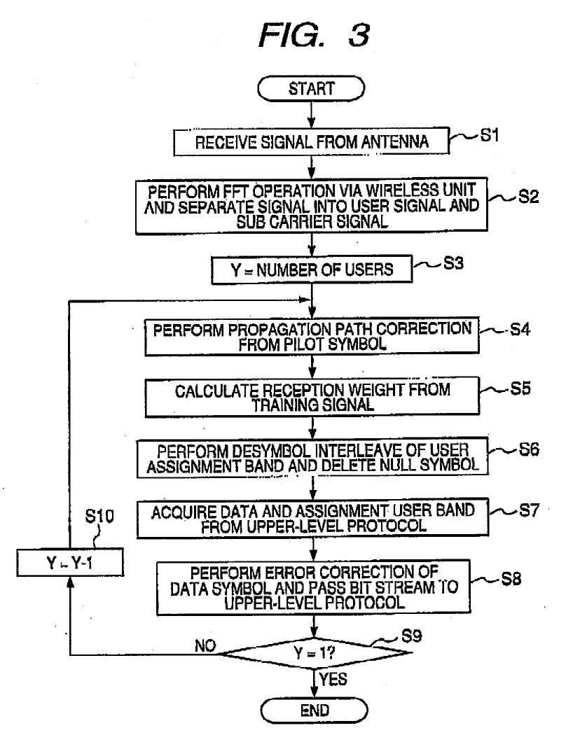

First, the reception process will be described with reference to FIG. 3. FIG. 3 is a flow chart to explain the reception process of a base station according to this embodiment.

In the reception process of base station 10 of this embodiment, a signal is received from an antenna (Step S1), and this signal is passed through wireless unit 1, subjected to FFT operation in FFT unit 3, and separated into user signals and carriers (Step S2).

Each of the separated user signals is passed to reception side user domain processor 4 to process the user signal for each user. The number of user signals is put into the variable Y (Y=number of users: Step S3). To process the user signals for each sub channel, reception weight calculating unit 5 performs propagation path correction from a pilot symbol (Step S4) and calculates reception weight from a training signal (Step S5).

Next, desymbol interleave unit 6 performs desymbol interleaving on a user assignment band and null symbol deleting unit 7 deletes null symbols and extracts desymbols (Step S6).

Data and an assignment user band are acquired from an upper-level protocol (Step S7).

Next, data demodulating unit 8 demodulates the data symbols, performs error correction on the data symbols, extracts a bit stream and passes the extracted bit stream to the upper-level protocol (Step S8). It is determined whether or not the value of variable Y is 1 (Step S9). If Y is not equal to 1 (NO in Step S9), Y is set as Y−1 (Step S10) and the next user process is performed from Step S4. If Y=1 (YES in Step S9), the process is ended since the process for all the user signals has been completed.

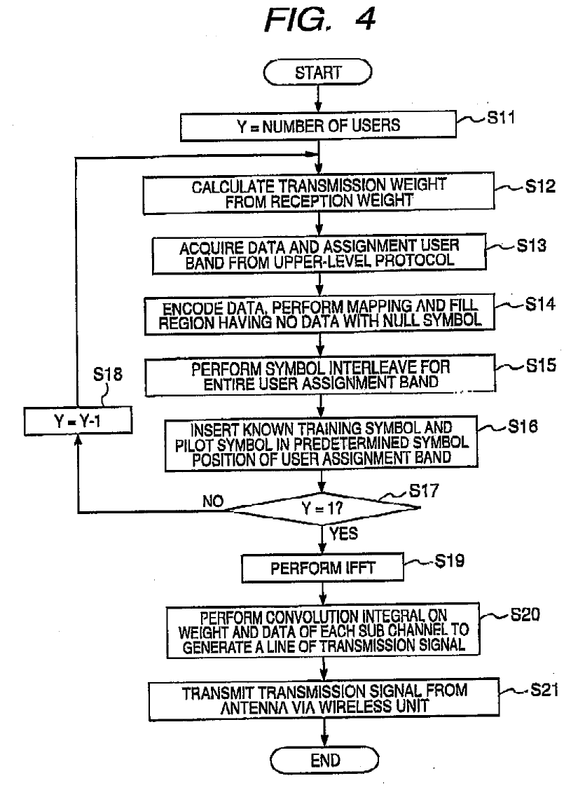

Next, transmission process will be described with reference to FIG. 4. FIG. 4 is a flow chart to explain the transmission process of a base station according to this embodiment.

In the transmission process of base station 10 of this embodiment, first the number of user signals is put into the variable Y (Y=number of users: Step S11), and transmission weight calculating unit 14 of transmission side user domain processor 9 calculates the transmission weight for each sub channel from the reception weight, performing this process for each user (Step S12).

Transmission side user domain processor 9 acquires communication network side data and a user assignment sub channel (user assignment band) in a predetermined format from an upper-level protocol (Step S13). Here, the sub channel is a minimal symbol block which conducts data communication of users.

Next, data producing unit 11 encodes the data and performs mapping for the user assignment sub channel. If the amount of data for the assigned sub channel is small, null symbol inserting unit 12 fills any region having no data with null symbols (Step S14).

Thereafter, symbol interleave unit 13 performs symbol interleaving over the user assignment band (Step S15) and inserts the known training symbol and pilot symbol in a determined symbol position within the user assignment band (Step S16).

After inserting the known training symbol and pilot symbol in the predetermined symbol position within the user assignment band, symbol interleave unit 13 may perform symbol interleaving over the user assignment band.

It is determined whether or not the value of variable Y is 1 (Step S17). If Y is not equal to 1 (NO in Step S17), Y is set as Y−1 (Step S18) and the next user process is performed from Step S12.

If Y=1 (YES in Step S17), transmission side user domain processor 9 produces data for each user and IFFT unit 15 performs IFFT operation (Step S19).

Antenna combining unit 16 performs convolution integral on transmission weight and data of each sub channel to generate a line of transmission signal (Step S20).

The transmission signal is transmitted from an antenna via wireless unit 1 (Step S21).

Next, a communication method of terminal 20 in the communication system according to this embodiment will be described.

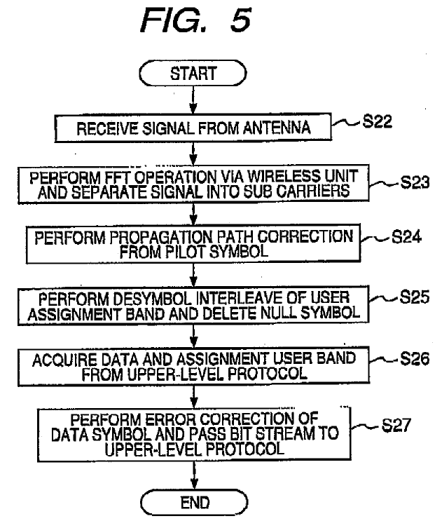

First, the reception process will be described with reference to FIG. 5. FIG. 5 is a flow chart to explain the reception process of a terminal according to this embodiment.

In the reception process of terminal 20 of this embodiment, a signal is received from an antenna (Step S22), and this signal is passed through wireless unit 21, subjected to FFT operation in FFT unit 23, and separated into signals for each sub carrier (Step S23).

Signal processor 22 performs propagation path correction from a pilot symbol of the signal for each sub carrier sent from FFT unit 23 (Step S24).

Next, desymbol interleave unit 6 performs desymbol interleaving of a user assignment band and null symbol deleting unit 7 deletes null symbols (Step S25).

Data and an assignment user band are acquired from an upper-level protocol (Step S26).

Next, data demodulating unit 8 demodulates data symbols, performs error correction on the data symbols, extracts a bit stream and passes the extracted bit stream to the upper-level protocol (Step S27).

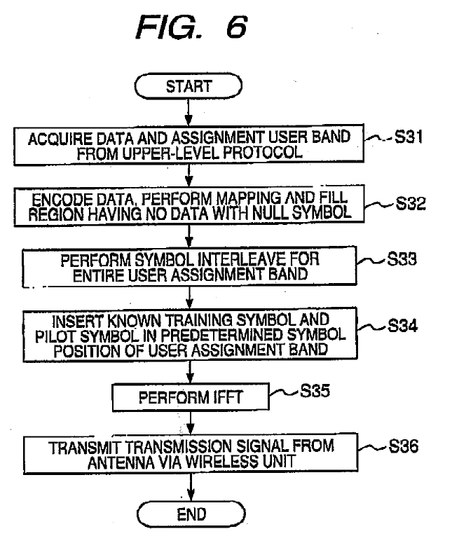

Next, the transmission process will be described with reference to FIG. 6. FIG. 6 is a flow chart for explaining the transmission process of a terminal according to this embodiment.

In the transmission process of terminal 20 of this embodiment, data and a user assignment sub channel (user band) of a communication network side are acquired in a predetermined format from an upper-level protocol (Step S31). Here, the sub channel is a minimal symbol block which conducts data communication of users.

Next, data producing unit 31 encodes and maps the data. If the number of sub channels of data for the band assignment is small, null symbol inserting unit 28 fills any region having no data with null symbols (Step S32).

Thereafter, symbol interleave unit 29 performs symbol interleaving over the user assignment band (Step S33) and inserts the known training symbol and pilot symbol in a determined symbol position within the user assignment band (Step S34).

After inserting the known training symbol and pilot symbol in the predetermined symbol position within the user assignment band, symbol interleave unit 29 may perform symbol interleaving over the user assignment band.

Next, IFFT unit 30 performs IFFT operation (Step S35), and a transmission signal is transmitted from an antenna via wireless unit 21 (Step S36).

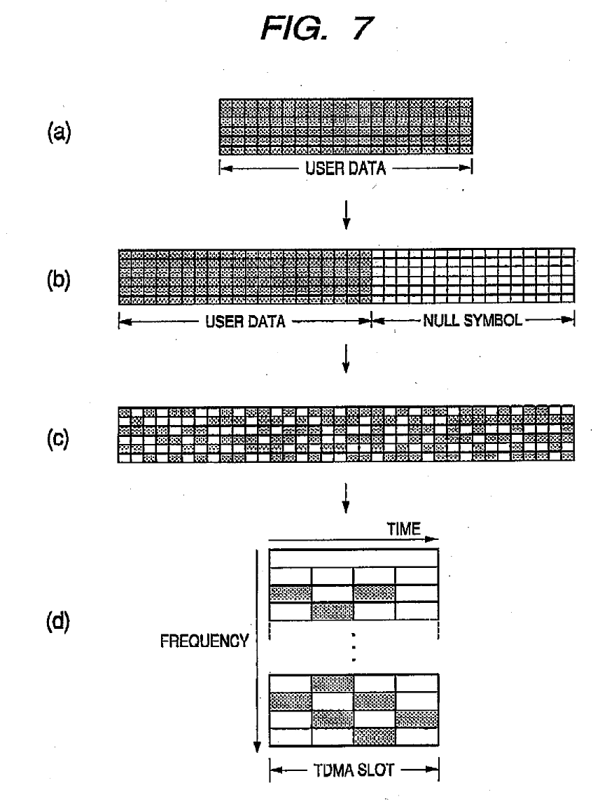

An example of the above-described method of inserting a symbol into a user assignment sub channel described in the communication method of base station 10 and terminal 20 in a communication system according to this embodiment will be described with reference to FIG. 7.

Data symbols are obtained by encoding and modulating user data, as shown in FIG. 7(a), received from an upper-level protocol.

Next, null symbols corresponding to the difference (see FIG. 7(b)) between the number of user assignment sub channels and the number of sub channels of data from the upper-level protocol are filled out.

Next, symbol interleaving is performed as shown in FIG. 7(c). As shown in FIG. 7(d), symbols are filled in sub channels of a band in which data after symbol interleave are assigned to the user assignment sub channel.

For desymbol interleaving, desymbol interleaving of a user assignment band is performed in reverse order to the above-mentioned order, null symbols are deleted and data symbols are extracted.

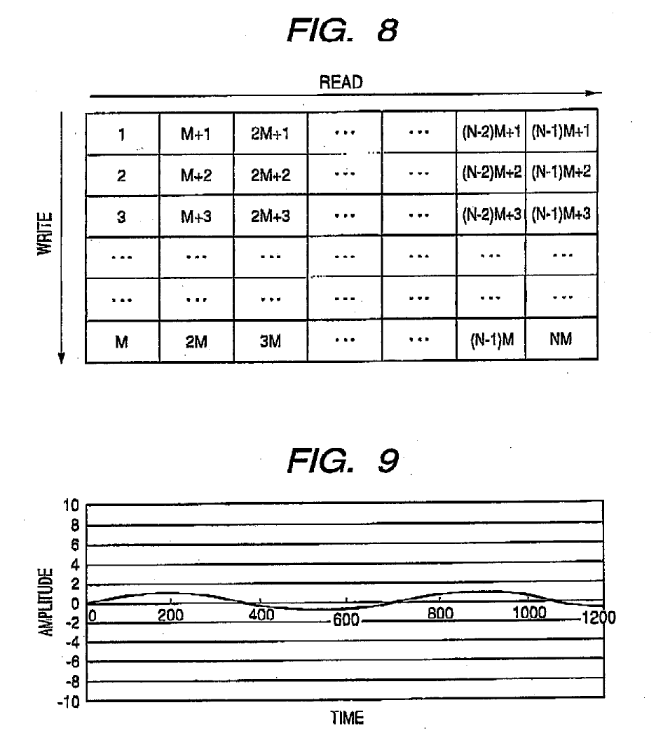

FIG. 8 is a view to explain an example of symbol interleaving in a communication method of base station 10 and terminal 20 of a communication system according to this embodiment. The example shown in FIG. 8 is symbol interleaving of a scheme in which symbols are read in predetermined block sections in a horizontal direction and are written in a vertical direction thereof.

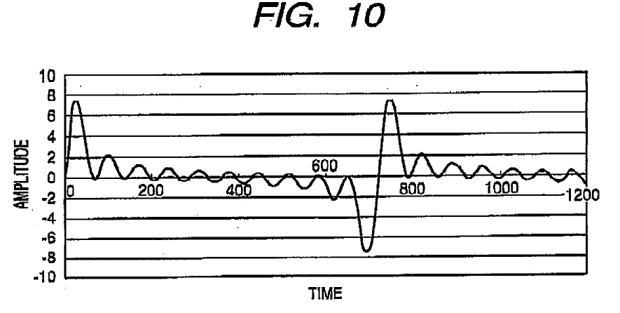

FIGS. 9 and 10 are waveform diagrams showing peak component by the difference in OFDM wave numbers with FIG. 9 showing an example of a combined wave including one sub carrier and FIG. 10 showing an example of a combined wave including 10 sub carriers.

In an OFDM-based communication method, as the wave number of an OFDM combined signal increases, it necessarily follows that the peak amplitude of a waveform of the combined signal becomes large as shown in FIG. 10.

According to the communication method of base station 10 and terminal 20 in the communication system of this embodiment, by filling data portions other than the training symbol required for weight operation or synchronization of an adaptive array with null symbols and performing symbol interleaving on all the user symbols, a wave number can be reduced to 7 or so with null symbol insertion in an OFDM combined signal, for example, while the wave number is 14 with no null symbol insertion, accordingly, it is possible to lower the probability of instant peak power raises, resulting in the alleviation of signal quality deterioration.

1. A communication system of an OFDM system, comprising:
data producing means for acquiring communication network side data and a user assignment band in a predetermined format, encoding the data, and performing mapping for the user assignment band;
null symbol inserting means for filling a region having no data with null symbols if the amount of data for the user assignment band is small; and
symbol interleave means for performing symbol interleave on the entire user assignment band and inserting known symbols in a predetermined symbol position within the user assignment band.

2. A base station that conducts a communication of an OFDM system, comprising:
a signal processor that processes a received signal and/or a signal to be transmitted,
wherein the signal processor includes a reception side user domain processor and/or a transmission side user domain processor that perform the process for each user, and
wherein the reception side user domain processor includes:
a reception weight calculating unit that performs propagation path correction from a pilot symbol and calculates reception weight from a training signal;
a desymbol interleave unit that performs desymbol interleave on a user assignment band; and
a null symbol deleting unit that deletes null symbols from the desymbol interleaved user assignment band and extracts desymbols.

3. The base station of claim 2, wherein the transmission side user domain processor includes:
a data producing unit that encodes data and performs mapping for the user assignment band;
a null symbol inserting unit that fills a region having no data with null symbols if the amount of data for the user assignment band is small; and
a symbol interleave unit that performs symbol interleave on the entire user assignment band and inserts known symbols in a predetermined symbol position within the user assignment band.

4. A terminal that conducts a communication of an OFDM system, comprising:
a signal processor that processes a received signal and/or a signal to be transmitted,
wherein the signal processor includes:
a data producing unit that encodes data and performs mapping for a user assignment band;
a null symbol inserting unit that fills a region having no data with null symbols if the amount of data for the user assignment band is small; and
a symbol interleave unit that performs symbol interleave on the entire user assignment band and inserts known symbols in a predetermined symbol position within the user assignment band.

5. A terminal that conducts a communication of an OFDM system, comprising:
a signal processor that processes a received signal and/or a signal to be transmitted,
wherein the signal processor includes:
a desymbol interleave unit that performs desymbol interleave on a user assignment band; and
a null symbol deleting unit that deletes null symbols from the desymbol interleaved user assignment band.

6. A communication method of an OFDM system, comprising the steps of:
acquiring communication network side data and a user assignment band in a predetermined format, encoding the data, and performing mapping for the user assignment band;
filling a region having no data with null symbols if the amount of data for the user assignment band is small; and
performing symbol interleave on the entire user assignment band and inserting known symbols in a predetermined symbol position within the user assignment band.
